(19) United States
(12) Patent Application Publication
(10) Pub. No.: US 2021/0228041 A1
(43) Pub. Date: Jul. 29, 2021

(54) RECHARGEABLE CLEANER

(71) Applicant: MAKITA CORPORATION, Anjo-shi, Aichi (JP)

(72) Inventor: Toru YAMADA, Anjo-shi (JP)

(73) Assignee: MAKITA CORPORATION, Anjo-shi, Aichi (JP)

(21) Appl. No.: 15/734,811

(22) PCT Filed: May 23, 2019
(86) PCT No.: PCT/JP2019/020518

§ 371 Date: Dec. 3, 2020

(30) Foreign Application Priority Data
Jun. 26, 2018 (JP) 2018-120350

(51) Int. Cl. A47L 9/28; H02J 7/00; H02J 50/10; H02J 50/80; A47L 5/24

(52) U.S. Cl. CPC A47L 9/2884; H02J 7/00; A47L 5/24; H02J 50/80; H02J 50/10

(57) ABSTRACT

A rechargeable cleaner includes a body, a rechargeable battery, a suction part, a handle part, and a power receiving coil. The body includes a motor configured to generate suction power capable of sucking dust together with air and a housing that houses the motor. The rechargeable battery is configured to supply electric power to the motor. The suction part has a suction port capable of sucking dust together with air by the suction power generated by the motor. The handle part is disposed at the body and is capable of being gripped by an operator. The power receiving coil is disposed at a flat surface part of the housing facing the handle part. The power receiving coil charges the battery by induced power generated by an electric current flowing through a power transmitting coil of a charger disposed facing the power receiving coil.

### FIELD

The present invention relates to a rechargeable cleaner.

### BACKGROUND

Widely known are technologies relating to a rechargeable cleaner that operates by electric power supplied from a rechargeable battery (refer to Patent Literature 1, for example). In Patent Literature 1, the rechargeable cleaner is charged by bringing into contact a terminal disposed on the back surface of the rechargeable cleaner and a terminal disposed at a charger with each other and by being electrically connected.

### CITATION LIST

### Patent Literature

Patent Literature 1: JP 2016-171730 A

### SUMMARY

### Technical Problem

If the terminals are brought into contact with each other to be electrically connected, the terminals may possibly be worn by repeated charging. In addition, dirt may possibly adhere to the terminal of the rechargeable cleaner because the terminal is disposed in an exposable manner in at least charging. Such abrasion of the terminals and adhesion of dirt thereto may possibly cause contact failure, thereby deteriorating a charging function. To maintain the charging function, it is necessary to check abrasion of the terminals and adhesion of dirt thereto and clean the terminals.

An object of an aspect of the present invention is to provide a rechargeable cleaner capable of being charged in a non-contact manner.

### Solution to Problem

According to an embodiment of the present invention, a rechargeable cleaner includes: a body including a motor configured to generate suction power capable of sucking dust together with air and a housing that houses the motor; a rechargeable battery configured to supply electric power to the motor; a suction part having a suction port capable of sucking dust together with air by the suction power generated by the motor; a handle part disposed at the body and capable of being gripped by an operator; and a power receiving coil disposed at a flat surface part of the housing facing the handle part. The power receiving coil charges the battery by induced power generated by an electric current flowing through a power transmitting coil of a charger disposed facing the power receiving coil.

According to an embodiment, a rechargeable cleaner includes: a body including a motor configured to generate suction power capable of sucking dust together with air and a housing that houses the motor; a rechargeable battery configured to supply electric power to the motor; a suction part having a suction port capable of sucking dust together with air by the suction power generated by the motor; and a power receiving coil disposed in the suction part. The power receiving coil charges the battery by induced power generated by an electric current flowing through a power transmitting coil of a charger disposed facing the power receiving coil.

A rechargeable cleaner comprising:
a body including a motor configured to generate suction power capable of sucking dust together with air and a housing that houses the motor;
a rechargeable battery configured to supply electric power to the motor;
a suction part having a suction port capable of sucking dust together with air by the suction power generated by the motor;
a pipe part that couples the body and the suction part; and
a power receiving coil disposed at a position facing a holding unit that holds at least one of the body, the suction part, and the pipe part, wherein
the power receiving coil charges the battery by induced power generated by an electric current flowing through a power transmitting coil of the holding unit disposed facing the power receiving coil.

### Advantageous Effects of Invention

An aspect of the present invention provides a rechargeable cleaner capable of being charged in a non-contact manner.

### BRIEF DESCRIPTION OF DRAWINGS

FIG. 1 is a perspective view illustrating an example of a rechargeable cleaner according to a first embodiment.

FIG. 2 is a side view illustrating an example of the rechargeable cleaner according to the first embodiment.

FIG. 3 is a sectional view illustrating an example of a body of the rechargeable cleaner according to the first embodiment.

FIG. 4 is a block diagram of an example of the configuration of a power receiver and a non-contact charger of the rechargeable cleaner according to the first embodiment.

FIG. 5 is a block diagram of an example of the configuration of a control circuit of the body of the rechargeable cleaner according to the first embodiment.

FIG. 6 is a bottom view illustrating an example of a nozzle unit of the rechargeable cleaner according to the first embodiment.

FIG. 7 is a view for explaining a method for charging the rechargeable cleaner according to the first embodiment.

FIG. 8 is a sectional view illustrating an example of the body of the rechargeable cleaner according to a second embodiment.

FIG. 9 is a bottom view illustrating an example of the nozzle unit of the rechargeable cleaner according to a third embodiment.

FIG. 10 is a view for explaining the method for charging the rechargeable cleaner according to the third embodiment.

FIG. 11 is a side view illustrating an example of the rechargeable cleaner according to a fourth embodiment.

FIG. 12 is a view for explaining the method for charging the rechargeable cleaner according to the fourth embodiment.

### DESCRIPTION OF EMBODIMENTS

Embodiments according to the present invention will be described below in greater detail with reference to the accompanying drawings. The embodiments are not intended to limit the present invention. Components in the embodiments below include components replaceable and easy to replace by those skilled in the art and components substantially identical therewith. Furthermore, the components described below may be appropriately combined. If there are a plurality of embodiments, they may be combined.

In the following description, an X-axis direction is referred to as a “front-back direction”. A Y-axis direction is referred to as a “left-right direction”. The Y-axis direction is horizontally orthogonal to the X-axis direction. In the direction toward the “front” in the front-back direction, the left side is “left”, and the right side is “right”. A Z-axis direction is referred to as an “up-down direction”. The Z-axis direction is orthogonal to the X-axis direction and the Y-axis direction.

### First Embodiment

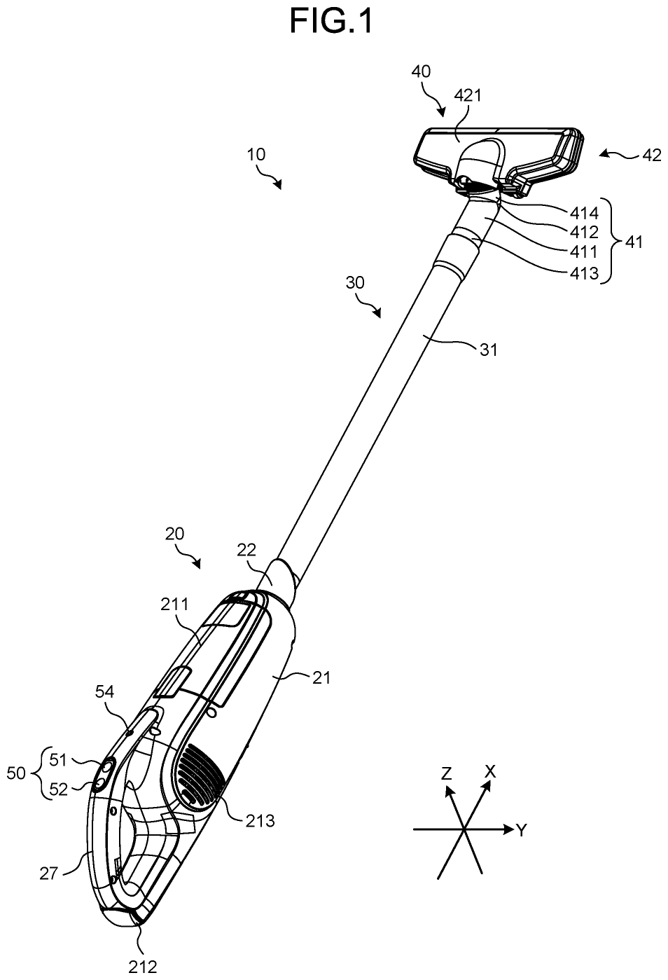

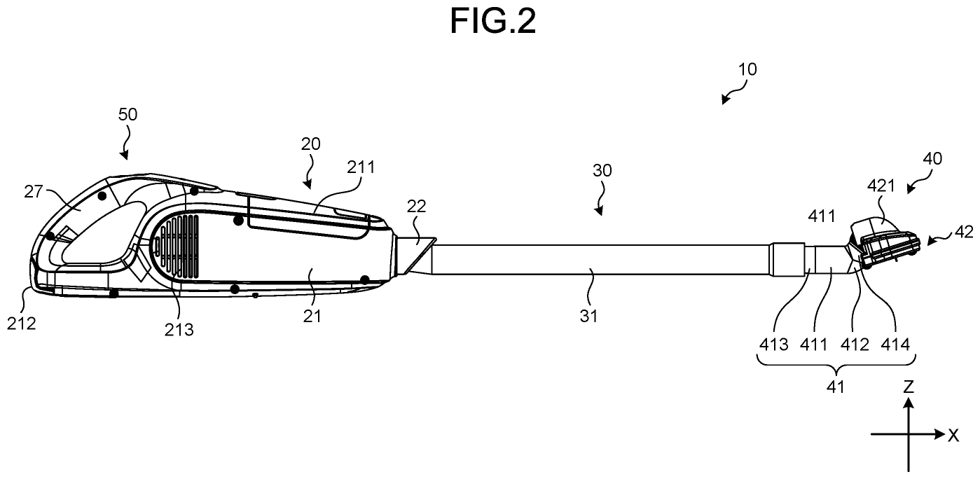

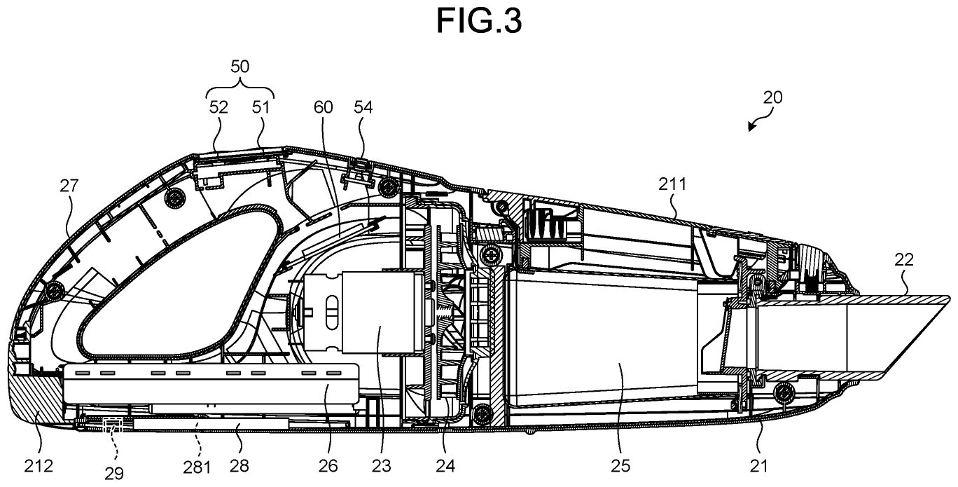

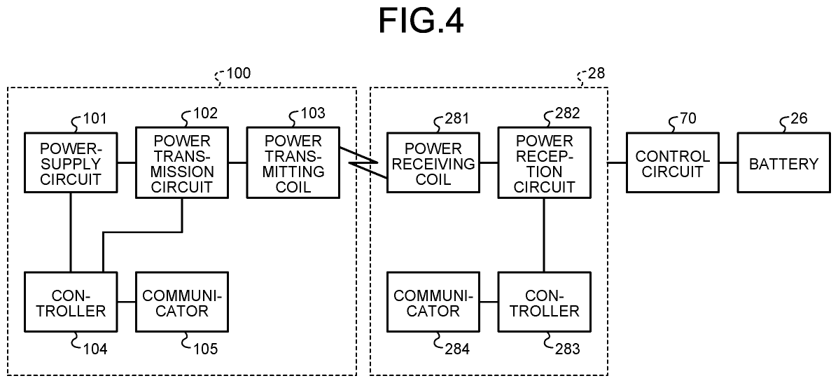

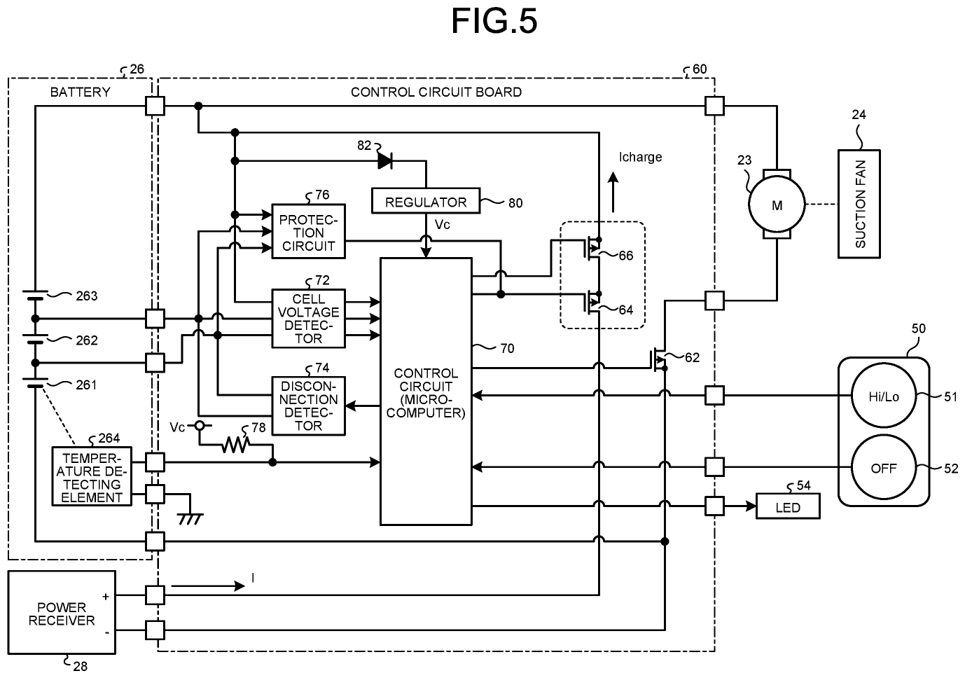

An outline of a rechargeable cleaner 10 is described with reference to FIGS. 1 to 5. FIG. 1 is a perspective view illustrating an example of the rechargeable cleaner according to a first embodiment. FIG. 2 is a side view illustrating an example of the rechargeable cleaner according to the first embodiment. FIG. 3 is a sectional view illustrating an example of the body of the rechargeable cleaner according to the first embodiment. FIG. 4 is a block diagram of an example of the configuration of a power receiver and a non-contact charger of the rechargeable cleaner according to the first embodiment. FIG. 5 is a block diagram of an example of the rechargeable cleaner according to the first embodiment. The rechargeable cleaner 10 operates by being supplied with electric power from a rechargeable battery pack (hereinafter, referred to as a “battery”) 26.

The rechargeable cleaner 10 includes a body unit (body) 20, a pipe unit (pipe part) 30, a nozzle unit (suction part) 40, a control circuit board 60, and a non-contact charger 100. The rechargeable cleaner 10 is charged in a non-contact manner using the non-contact charger 100. The method for non-contact charging may be a known method, such as an electromagnetic induction method, and is not limited.

The body unit 20 generates suction power capable of sucking dust together with air. The body unit 20 includes a case (housing) 21, a suction port 22, a motor 23, a suction fan 24, a dust collection filter (dust collection part) 25, a battery 26, a handle (handle part) 27, a power receiver 28, and an engagement recess 29.

The case 21 defines the outer shape of the body unit 20. The case 21 houses the motor 23, the suction fan 24, the dust collection filter 25, the battery 26, and the power receiver 28. The case 21 has a cylindrical shape. The case 21 according to the present embodiment has a flat surface part on the bottom surface. The flat surface part includes a position facing at least the handle 27. The case 21 includes an opening/closing cover 211, a lid 212, and an exhaust port 213.

The opening/closing cover 211 forms a part of the outer periphery of the case 21. The opening/closing cover 211 is disposed at the upper front part of the outer periphery of the case 21. The opening/closing cover 211 opens and closes with respect to the case 21. With the opening/closing cover 211 opened, the dust collection filter 25 can be taken in and out.

The lid 212 forms a part of the outer periphery of the case 21. The lid 212 is disposed at a rear lower part of the outer periphery of the case 21. The lid 212 opens and closes with respect to the case 21. With the lid 212 opened, the battery 26 can be taken in and out.

The exhaust port 213 communicates between the inside and the outside of the case 21. The exhaust port 213 discharges air sucked from the suction port 22 to the outside of the case 21. The exhaust port 213 discharges air heated by rotation of the motor 23 to the outside of the case 21. The exhaust port 213 discharges air in the rechargeable cleaner 10 to the outside of the case 21 by rotation of the suction fan 24.

The exhaust port 213 is formed at a middle part of the case 21 in the front-back direction. More specifically, the exhaust port 213 is formed on the outer side in the radial direction of the motor 23.

The suction port 22 is a port through which dust is sucked into the dust collection filter 25 together with air. The suction port 22 communicates between the inside and the outside of the case 21. The suction port 22 is disposed at the front end of the case 21. To the suction port 22, the pipe unit 30 can be coupled. Through the suction port 22, external air is sucked into a housing 2 via the pipe unit 30 when the suction fan 24 rotates.

The motor 23 rotates, thereby rotating the suction fan 24 for generating suction power capable of sucking dust together with air. The motor 23 rotates by electric power supplied from the battery 26. The motor 23 is coupled to the suction fan 24 with an output shaft. In the case 21, the motor 23 is disposed behind the suction port 22, the suction fan 24, and the dust collection filter 25. The rotation speed of the motor 23 may be adjustable. The rotation speed of the motor 23 according to the present embodiment can be adjusted in three stages. The rotation speed of the motor 23 is controlled via a control circuit 70 of the control circuit board 60.

The suction fan 24 generates suction power capable of sucking dust together with air when the motor 23 rotates. The suction fan 24 generates an air flow capable of sucking dust together with air. In the case 21, the suction fan 24 is disposed in front of the motor 23 and behind the dust collection filter 25. The suction fan 24 is coupled to a rotating shaft of the motor 23. The suction fan 24 rotates when the motor 23 rotates. When the suction fan 24 rotates, air is sucked into the case 21 from the suction port 22. The air flow volume of the suction fan 24 can be adjusted corresponding to the rotation speed of the motor 23. The airflow volume of the suction fan 24 according to the present embodiment can be adjusted in three stages. The airflow volume of the suction fan 24 varies depending on the operating mode of the rechargeable cleaner 10.

The dust collection filter 25 removes and collects dust included in the sucked air. The dust collection filter 25 has a cylindrical shape with one end open and the other end closed. The dust collection filter 25 is housed in the case 21. More specifically, the dust collection filter 25 is disposed behind the suction port 22 in the case 21. The dust collection filter 25 is disposed on a front side of the suction fan 24 in the case 21. The opening of the dust collection filter 25 faces the suction port 22. In other words, the dust collection filter 25 communicates with the suction port 22 via the opening. The dust collection filter 25 causes air sucked from the suction port 22 to pass therethrough and causes dust included in the air to remain therein. The air having passed through the dust collection filter 25 is discharged from the exhaust port 213. The dust collection filter 25 can be attached and detached with the opening/closing cover 211 opened.

The battery 26 is a rechargeable battery. The battery 26 supplies electric power to the motor 23 of the rechargeable cleaner 10. The battery 26 is composed of a plurality of cells connected to each other. The battery 26 according to the present embodiment includes cells 261, 262, and 263 connected in series. The battery 26 is disposed at a rear lower part in the case 21. The battery 26 is disposed facing the handle 27. The battery 26 can be attached to and detached from the inside of the case 21 with the lid 212 opened. The battery 26 includes a temperature detecting element 264 that detects the temperature of the cells 261, 262, and 263. The battery 26 is electrically connected to the control circuit 70 of the control circuit board 60.

The temperature detecting element 264 detects the temperature of the battery 26. The temperature detecting element 264 is disposed in the battery 26. The temperature detecting element 264 outputs the detected temperature of the battery 26 to the control circuit 70.

The handle 27 is a grip gripped by a user. The handle 27 is disposed at a rear upper part of the case 21. The handle 27 is disposed above the battery 26 housed in the case 21.

The following describes the power receiver 28 with reference to FIGS. 3 to 5. The power receiver 28 receives electric power from the non-contact charger 100 in a non-contact manner. The power receiver 28 is disposed on a lower side of the battery 26 in the case 21. The power receiver 28 is disposed on a lower side of the handle 27 in the case 21. The power receiver 28 is disposed at a rear part of the body unit 20. The power receiver 28 is disposed facing the flat surface part of the bottom surface of the case 21. The power receiver 28 is electrically connected to the battery 26 via the control circuit 70 of the control circuit board 60. The power receiver 28 includes a power receiving coil 281, a power reception circuit 282, a controller 283, and a communicator 284.

The power receiving coil 281 receives electric power from a power transmitting coil 103 of the non-contact charger 100 in a non-contact manner. More specifically, the power receiving coil 281 charges the battery 26 by induced power generated by an electric current flowing through the power transmitting coil 103 disposed facing the power receiving coil 281. The power receiving coil 281 is disposed facing the outer periphery of the case 21. The power receiving coil 281 is disposed along the battery 26.

The power reception circuit 282 includes a rectifier and a DC/DC converter, which are not illustrated. The rectifier rectifies received AC power into DC power. The DC/DC converter converts a generated DC voltage into a voltage suitable for charging. In this manner, the power reception circuit 282 supplies electric power suitable for charging to the control circuit board 60.

The controller 283 includes a central processing unit (CPU) that performs arithmetic processing and a memory that stores therein computer programs. The controller 283 can output control signals for controlling the non-contact charger 100 via the communicator 284. When the controller 283 is notified of completion of charging by the control circuit 70, for example, the controller 283 can output an electrical signal for stopping power transmission. When the controller 283 is notified of stop of charging by the control circuit 70, for example, the controller 283 can output an electrical signal for stopping power transmission. When the rechargeable cleaner 10 is attached to the non-contact charger 100, that is, only when the rechargeable cleaner 10 and the non-contact charger 100 can communicate with each other, for example, the controller 283 can output an electrical signal for starting power transmission. The controller 283, for example, can output an electrical signal for adjusting power to be transmitted.

The communicator 284 can communicate with a communicator 105 of the non-contact charger 100. The communicator 284 can communicate with the non-contact charger 100 wirelessly via short-distance communications, such as Bluetooth (registered trademark), near-field communications (NFC), infrared communications, and Wi-Fi (registered trademark).

The engagement recess 29 positions the power receiver 28 and the non-contact charger 100. More specifically, the engagement recess 29 positions the power receiving coil 281 of the power receiver 28 and the power transmitting coil 103 of the non-contact charger 100. The engagement recess 29 has a concave shape and is formed on the bottom surface of the case 21. The engagement recess 29 has such a size and a shape that it engages with an engagement protrusion 111 of a holder (holding unit) 110 of the non-contact charger 100. The engagement recess 29 according to the present embodiment has a columnar shape. The engagement recess 29 according to the present embodiment is formed behind the power receiving coil 281. When the engagement recess 29 engages with the engagement protrusion 111 of the holder 110 of the non-contact charger 100, the power receiving coil 281 faces the power transmitting coil 103 of the non-contact charger 100. When the engagement recess 29 engages with the engagement protrusion 111, the power receiving coil 281 and the power transmitting coil 103 face each other, thereby increasing power transmission efficiency.

The pipe unit 30 allows air and dust sucked from the nozzle unit 40 to pass therethrough. The pipe unit 30 is attachable to and detachable from the suction port 22 and the nozzle unit 40. The pipe unit 30 connects the suction port 22 and the nozzle unit 40. The pipe unit 30 includes a pipe member 31. The pipe member 31 has a cylindrical shape. The front end of the pipe member 31 can be coupled to the nozzle unit 40. The back end of the pipe member 31 can be coupled to the suction port 22.

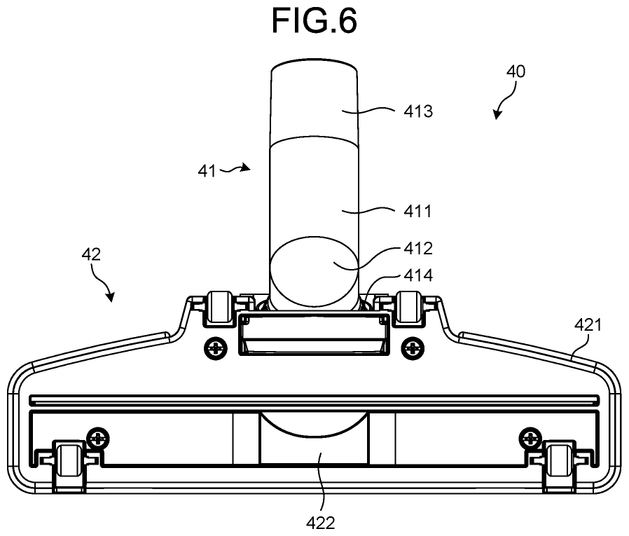

The following describes the nozzle unit 40 with reference to FIG. 6. FIG. 6 is a bottom view illustrating an example of the nozzle unit of the rechargeable cleaner according to the first embodiment. The nozzle unit 40 sucks air and dust. The nozzle unit 40 is attachable to and detachable from the front end of the pipe member 31 of the pipe unit 30. The nozzle unit 40 includes a coupler 41 and a head 42.

The coupler 41 can be coupled to the front end of the pipe member 31 of the pipe unit 30. The coupler 41 has a pipe shape. The coupler 41 includes a tubular pipe member 411. The pipe member 411 includes a bent part 412, a pipe unit coupler 413, and a head unit coupler 414. The bent part 412, the pipe unit coupler 413, and the head unit coupler 414 are integrated. The middle part of the pipe member 411 is the bent part 412. The pipe member 411 has a bent shape in a side view. The pipe unit coupler 413 is positioned behind the bent part 412 of the pipe member 411, and the head unit coupler 414 is positioned in front of the bent part 412. The pipe unit coupler 413 and the head unit coupler 414 extend along different directions.

The pipe unit coupler 413 can be coupled to the front end of the pipe member 31. The end of the pipe unit coupler 413 has such a size that it can fit into the pipe member 31. The diameter of the end of the pipe unit coupler 413 according to the present embodiment is smaller than the diameter of the front end of the pipe member 31.

The head 42 is rotatably coupled to the head unit coupler 414.

The head 42 is a suction port through which air and dust are sucked. The head 42 includes a housing 421 and a suction port 422. The head 42 is coupled to the head unit coupler 414 so as to be relatively rotatable in the circumferential direction of the pipe member 31. The housing 421 has a box shape extending in the left-right direction. The housing 421 can house various members. The suction port 422 is an opening formed on the bottom surface of the housing 421. The suction port 422 communicates with the coupler 41.

An operating switch 50 is disposed above the handle 27. The operating switch 50 is an electronic switch that can receive various operations performed on the rechargeable cleaner 10. The operating switch 50 can be operated when the user grips the handle 27. The operating switch 50 includes a drive switch 51 and a stop switch 52.

The drive switch 51 is pressed and operated by the user to switch the operating mode indicating the strength of suction power of the rechargeable cleaner 10. In the present embodiment, every time the drive switch 51 is pressed, the drive switch 51 can switch the operating mode between high (high mode), normal (low mode), and turbo (high-power mode). The high mode is a mode for rotating the motor 23 at high speed. The low mode is a mode for rotating the motor 16 at lower speed than the high mode. The high-power mode is a mode for rotating the motor 23 at higher speed than the high mode. Every time the drive switch 51 is pressed, the drive switch 51 outputs an electrical signal corresponding to the operating information to the control circuit 70.

The stop switch 52 is pressed and operated by the user to stop the operation of the rechargeable cleaner 10. When the stop switch 52 is pressed while the rechargeable cleaner 10 is operating, the stop switch 52 can stop the operation. When the stop switch 52 is pressed, the stop switch 52 outputs an electrical signal corresponding to the operating information to the control circuit 70.

An LED 54 is disposed on a front side of the operating switch 50. The LED 54 is turned on to indicate a charging state when the rechargeable cleaner 10 is being charged. The LED 54, for example, is turned on in red in charging and turned off when the rechargeable cleaner 10 is not being charged or is fully charged. The lighting state of the LED 54 is controlled by the body control circuit 70.

The control circuit board 60 is disposed on an upper side of the motor 23 and on a lower side of the operating switch 50 in the case 21. The control circuit board 60 has a function of receiving electric power from the power receiver 28 and charging the battery 26 and a function of receiving electric power from the battery 26 and discharging it to the motor 23. In other words, the control circuit board 60 has a discharging circuit and a charging circuit. The discharging circuit is a circuit for flowing an electric current from the positive side of the battery 26 to the negative side of the battery 26 via the motor 23, that is, a circuit for discharging the battery 26. The charging circuit is a circuit that connects the positive terminal of the power receiver 28 to the positive side of the battery 26 and connects the negative terminal of the power receiver 28 to the negative side of the battery 26, that is, a circuit for charging the battery 26. The control circuit board 60 is provided with electronic parts that implement these functions.

The following describes the control circuit board 60 with reference to FIG. 5. The control circuit board 60 includes a discharging control field effect transistor (FET) 62, a charging control FET 64, a charging protection FET 66, the control circuit 70, a cell voltage detector 72, a disconnection detector 74, a protection circuit 76, a resistance 78, a regulator 80, and a diode 82.

The discharging control FET 62 controls a discharging current from the battery 26 to the motor 23, that is, a drive current for the motor 23. The discharging control FET 62 is disposed downstream of the motor 23 in the discharging circuit, that is, on the negative side of the battery 26.

The charging control FET 64 and the charging protection FET 66 are disposed in a manner connected in series on the charging circuit from the positive terminal of the power receiver 28 to the negative side of the battery 26 in the charging circuit. The charging control FET 64 controls a charging current from the power receiver 28 to the battery 26. The charging protection FET 66 protects the battery 26 from overcurrent and overcharge in charging.

The discharging control FET 62, the charging control FET 64, and the charging protection FET 66 are semiconductor switching devices that cause an electric current to flow through or be cut off in the discharging circuit or the charging circuit. The discharging control FET 62, the charging control FET 64, and the charging protection FET 66 are driven by the control circuit 70.

The cell voltage detector 72 detects output voltages of the cells 261, 262, and 263 of the battery 26. The cell voltage detector 72 outputs detection signals indicating the voltages of the cells 261, 262, and 263 to the control circuit 70.

The disconnection detector 74 detects disconnection in the battery 26 based on the cell voltages detected by the cell voltage detector 72 by setting the connections between the cells 261, 262, and 263 in the battery 26 to a predetermined potential.

The protection circuit 76 acquires the voltages from the cells 261, 262, and 263 in charging the battery 26. If the acquired voltage reaches a threshold higher than an overvoltage determination value, that is, if overvoltage protection by the control circuit 70 fails to normally function, the protection circuit 76 forcibly turns off the charging control FET 64 to forcibly stop charging the battery 26.

The regulator 80 supplies an operating power-supply voltage, more specifically, a DC constant voltage to the control circuit 70. The regulator 80 can be supplied with a DC voltage from the battery 26 via the diode 82. The regulator 80 generates the DC constant voltage for driving the control circuit 70 from the DC voltage supplied from the battery 26.

The control circuit 70 includes a CPU that performs arithmetic processing and a memory that stores therein computer programs. The control circuit 70 operates by electric power supplied from the regulator 80. The control circuit 70 rotates the motor 23 and charges the battery 26 by switching on and off the discharging control FET 62, the charging control FET 64, and the charging protection FET 66 according to a control program stored in the memory.

If the drive switch 51 is operated when the motor 23 is being stopped, the control circuit 70 sets the operating mode to the high mode, for example, as an initial operating mode. After the initial operating mode is set, the body control circuit 70 switches the operating mode depending on whether the drive switch 51 is operated or on operating duration, that is, duration of the ON state until the stop switch 52 is operated.

Every time the drive switch 51 is operated when the motor 23 is operating, the control circuit 70 controls the rotation speed of the motor 23 depending on the operating mode. When the drive switch 51 is operated to select the high mode, the control circuit 70 performs control such that the rotation speed of the motor 23 is a high speed corresponding to the high mode. When the drive switch 51 is operated to select the low mode, the control circuit 70 performs control such that the rotation speed of the motor 23 is a normal speed corresponding to the low mode. When the drive switch 51 is operated to select the high-power mode, the control circuit 70 performs control such that the rotation speed of the motor 23 is a high speed corresponding to the high-power mode. More specifically, every time the drive switch 51 is operated, the control circuit 70 generates a pulse width modulation (PWM) signal of the duty ratio corresponding to the operating mode. The control circuit 70 outputs the PWM signal to the discharging control FET 62 to control the discharging control FET 62. As a result, a drive current corresponding to the duty ratio of the PWM signal flows through the motor 23, and the motor 23 rotates at a rotation speed corresponding to the drive current. The amount of suction power of the rechargeable cleaner 10 is controlled corresponding to the operating modes.

The memory of the control circuit 70 stores therein the duty ratios for driving the discharging control FET 62 set for the respective operating modes as control data for rotating the motor 23 in the operating modes. The duty ratio for driving is set for each operating mode. The duty ratio for driving is set small (e.g., a value smaller than 50%) for the low mode, large (e.g., 100%) for the high-power mode, and medium (e.g., a value of 50% or larger and smaller than 100%) for the high mode.

If the stop switch 52 is operated when the motor 23 is rotating, the control circuit 70 turns off the discharging control FET 62 to stop the rotation of the motor 23.

If the power receiver 28 receives electric power from the non-contact charger 100, and the state of the battery 26 satisfies a charging start condition when drive of the motor 23 is being stopped, the control circuit 70 switches the charging control FET 64 and the charging protection FET 66 from the OFF state to the ON state and starts to charge the battery 26. More specifically, the control circuit 70 generates a PWM signal of a predetermined duty ratio. The control circuit 70 outputs the PWM signal to the charging control FET 64 to control the charging control FET 64. As a result, a charging current corresponding to the duty ratio of the PWM signal flows through the battery 26.

The charging start condition of the battery 26 is that the remaining charge of the battery 26 is lower than a threshold for determining whether to start charging. More specifically, the charging start condition of the battery 26 is that the output voltage from the battery 26 is lower than a threshold voltage for determining whether to start charging. Alternatively, the charging start condition of the battery 26 is that the temperature detected by the temperature detecting element 264 falls within a specified range.

If the output voltage from the battery 26 starts to drop during constant current charging with a constant current, in other words, if the output voltage from the battery 26 reaches the threshold voltage, the control circuit 70 switches to constant voltage charging at a constant voltage. As a result, the battery 26 can be fully charged to the rated capacity.

Charging control on the battery 26 is continuously performed by the control circuit 70 until the battery 26 is fully charged. When the battery 26 is fully charged after charging the battery 26 is started, the control circuit 70 turns off the charging control FET 64 and the charging protection FET 66 to finish charging the battery 26. When the battery 26 is fully charged, the control circuit 70 outputs an electrical signal for notifying the controller 283 of the power receiver 20 of completion of charging to the controller 283.

The memory of the control circuit 70 stores therein the duty ratio for driving the charging control FET 64 as control data for controlling charging.

To perform charging/discharging control, the control circuit 70 monitors the output voltage from the battery 26 and various parameters, such as output voltages from the cells 261, 262, and 263, temperature of the battery 26, and whether disconnection occurs in the battery 26. When the parameters are in an abnormal state, the control circuit 70 turns off the charging protection FET 66 or the discharging control FET 62 to stop charging or discharging the battery 26. When charging has been stopped, the control circuit 70 outputs an electrical signal for notifying the controller 283 of the power receiver 20 of stop of charging to the controller 283.

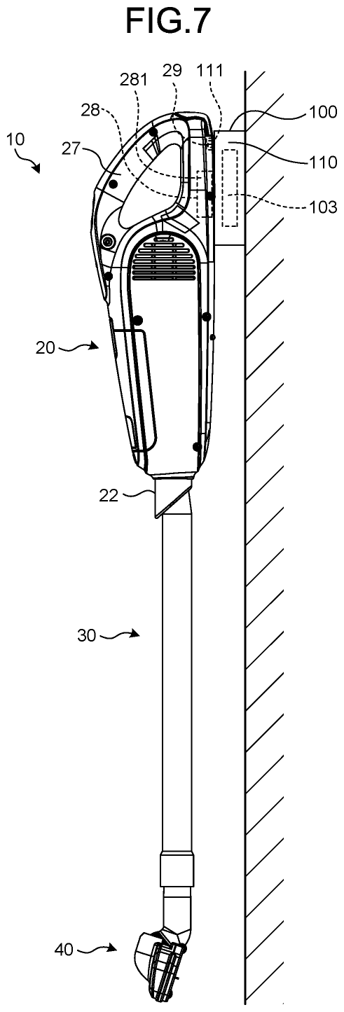

The following describes the non-contact charger 100 with reference to FIGS. 4 and 7. FIG. 7 is a view for explaining a method for charging the rechargeable cleaner according to the first embodiment. The non-contact charger 100 includes a power-supply circuit 101, a power transmission circuit 102, the power transmitting coil 103, a controller 104, a communicator 105, and the holder 110.

The power-supply circuit 101 supplies AC power supplied from an AC power source to the power transmission circuit 102 and the controller 104 of the non-contact charger 100.

The power transmission circuit 102 includes a transmitter and a power amplifier, which are not illustrated. The transmitter generates a high-frequency signal. The power amplifier amplifies the generated high-frequency signal. The power transmission circuit 102 converts a DC voltage supplied from the power-supply circuit 101 into AC, generates high-frequency power, and transmits the electric power from the power transmitting coil 103.

The controller 104 includes a CPU that performs arithmetic processing and a memory that stores therein computer programs. The controller 104 controls electric power transmitted from the transmission circuit 102 to the power receiver 28. The controller 104 performs control based on electrical signals received from the rechargeable cleaner 10 via the communicator 105. If the controller 104 receives an electrical signal for stopping power transmission, for example, the controller 104 performs control to stop power transmission. If the controller 104 receives an electrical signal for starting power transmission, for example, the controller 104 performs control to start power transmission. If the rechargeable cleaner 10 is detached from the non-contact charger 100 or fails to communicate with the non-contact charger 100, the controller 104 performs control to stop power transmission.

The communicator 105 can communicate with the communicator 284 of the power receiver 28. The communicator 105 can communicate with the rechargeable cleaner 10 wirelessly using standards of short-distance communications, such as Bluetooth, NFC, infrared communications, and Wi-Fi.

The holder 110 holds the body unit 20 of the rechargeable cleaner 10. The holder 110 has a plate shape. The power-supply circuit 101, the power transmission circuit 102, the power transmitting coil 103, the controller 104, and the communicator 105 are disposed in the holder 110. The holder 110 is fixed to a wall surface, for example. The holder 110 includes the engagement protrusion 111 that engages with the engagement recess 29 formed in the case 21. The engagement protrusion 111 protrudes from the outer periphery of the holder 110. The engagement protrusion 111 according to the present embodiment has a columnar shape.

The following describes the method for charging the rechargeable cleaner 10.

The user grips the handle 27 of the rechargeable cleaner 10 and attaches the body unit 20 to the holder 110 of the non-contact charger 100 disposed on the wall surface. The user engages the engagement recess 29 of the body unit 20 with the engagement protrusion 111 of the holder 110 of the non-contact charger 100. As a result, the power receiving coil 281 faces the power transmitting coil 103 of the non-contact charger 100. The power receiving coil 281 faces the power transmitting coil 103, whereby charging the battery 26 is started.

As described above, when the body unit 20 according to the present embodiment is attached to the holder 110 of the non-contact charger 100, the power receiving coil 281 and the power transmitting coil 103 face each other, thereby supplying the battery 26 with electric power. Consequently, the rechargeable cleaner 10 according to the present embodiment can be charged in a non-contact manner.

The engagement recess 29 for positioning with respect to the holder 110 according to the present embodiment is disposed on the lower side of the handle 27. Consequently, in the present embodiment, the user easily positions facilitates the user's positioning the holder 110 and the body unit 20 while gripping the handle 27.

The rechargeable cleaner 10 according to the present embodiment can be easily charged simply by attaching the body unit 20 to the holder 110 of the non-contact charger 100. The present embodiment enables a user unfamiliar with handling electrical equipment to easily charge the rechargeable cleaner 10 because a terminal of a charging adapter need not be connected to a terminal of the body unit.

A terminal made of metal material need not be disposed in a manner exposed on the outer periphery of the rechargeable cleaner 10 according to the present embodiment because the rechargeable cleaner 10 can be charged in a non-contact manner. With this configuration, the present embodiment prevents adhesion of dirt to the terminal. In addition, terminals are not worn because charging is performed not by bringing the terminals into contact with each other. Consequently, the present embodiment can prevent deterioration of charging performance caused by contact failure due to the terminals.

By contrast, to charge the rechargeable cleaner 10 by connecting a charging adapter to a terminal of the rechargeable cleaner 10, it is necessary to check and clean the terminal to prevent deterioration of the charging performance because of dirt or abrasion of the terminal.

The present embodiment does not require the trouble of checking and cleaning the terminal to maintain the charging performance.

In addition, the present embodiment is suitably used at work sites where dust is generated because a terminal need not be disposed in an exposed manner.

### Second Embodiment

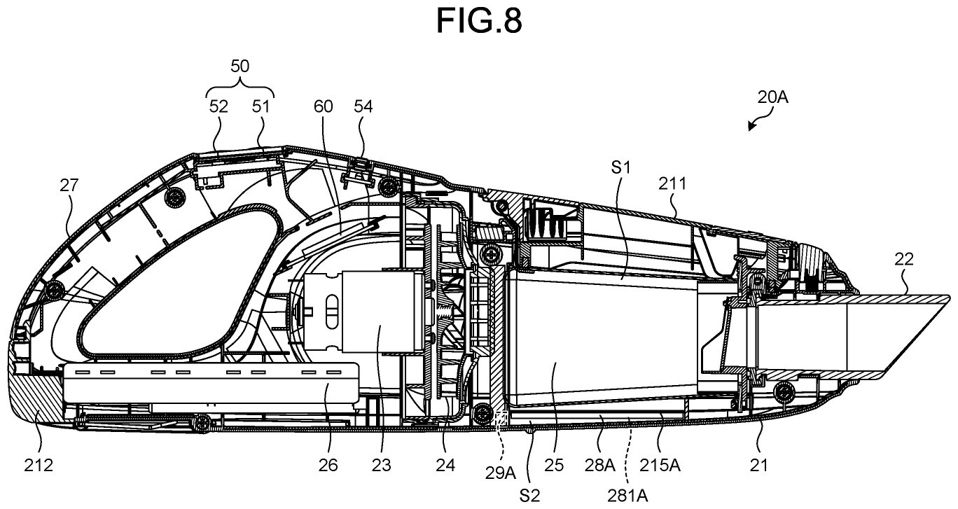

The following describes the rechargeable cleaner 10 according to the present embodiment with reference to FIG. 8. FIG. 8 is a sectional view illustrating an example of the body of the rechargeable cleaner according to a second embodiment. The basic configuration of the rechargeable cleaner 10 is the same as that of the rechargeable cleaner 10 according to the first embodiment. In the following description, components similar to those of the rechargeable cleaner 10 are denoted by like or corresponding reference numerals, and detailed explanation thereof is omitted. The present embodiment is different from the first embodiment in the position of a power receiver 28A in a body unit 20A.

The case 21 includes a partition wall 215A that separates a space S1 and a space (housing part) S2. The space S1 houses the dust collection filter 25, and the space S2 houses the power receiver 28A. The space S1 that houses the dust collection filter 25 and the space S2 that houses the power receiver 28A are provided side by side. The flat surface part of the case 21 includes a position facing at least the opening/closing cover 211.

The partition wall 215A is disposed on a lower side of the opening/closing cover 211 in the case 21. The partition wall 215A is disposed at a lower part of the case 21. In the case 21, the part above the partition wall 215A is the space S1 that houses the dust collection filter 25, and the part on a lower side of the partition wall 215A is the space S2 that houses the power receiver 28A.

The power receiver 28A is housed in the space S2 under the partition wall 215A in the case 21. A power receiving coil 281A of the power receiver 28A is disposed near the dust collection filter 25. More specifically, the power receiving coil 281A is disposed under the dust collection filter 25 in the case 21. The power receiving coil 281A is disposed at a front lower part of the body unit 20A. The power receiving coil 281A is disposed along the flat surface part of the case 21.

An engagement recess 29A is disposed at a middle part in the front-back direction on the outer periphery of the case 21.

As described above, the partition wall 215A according to the present embodiment separates the space S2 that houses the power receiver 28A from the space S1 that houses the dust collection filter 25. Consequently, the present embodiment can prevent dust having passed through the dust collection filter 25 from adhering to the power receiver 28A.

The power receiver 28A according to the present embodiment can be disposed away from the battery 26. Consequently, the present embodiment can prevent reduction in the space that houses the battery 26.

### Third Embodiment

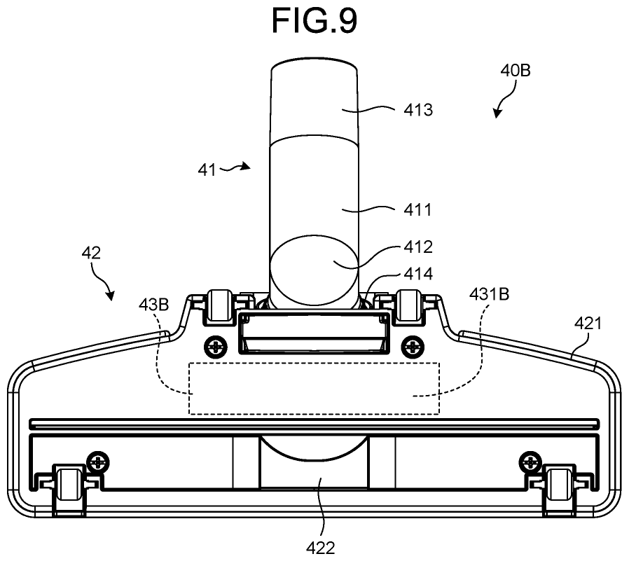

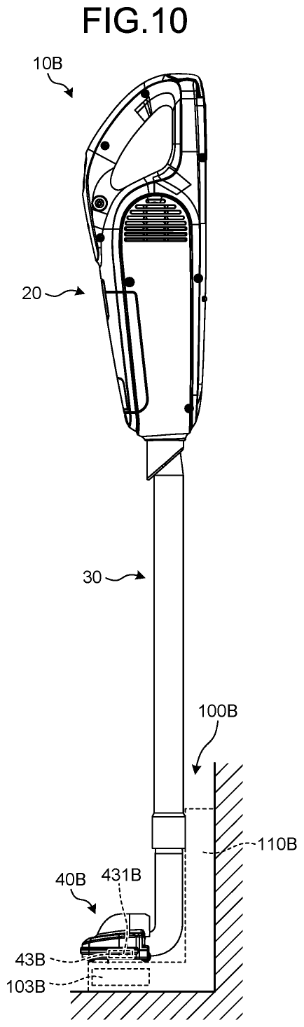

The following describes a rechargeable cleaner 10B according to the present embodiment with reference to FIGS. 9 and 10. FIG. 9 is a bottom view illustrating an example of a nozzle unit of the rechargeable cleaner according to a third embodiment. FIG. 10 is a view for explaining the method for charging the rechargeable cleaner according to the third embodiment. The present embodiment is different from the first embodiment in that a power receiver 43B is disposed in a nozzle unit 40B.

The nozzle unit 40B includes the power receiver 43B.

The power receiver 43B is disposed in the nozzle unit 40B. A power receiving coil 431B of the power receiver 43B is disposed at a lower part in the housing 421 of the head 42. The power receiving coil 431B is disposed at a middle part between the head unit coupler 414 and the suction port 422. The power receiving coil 431B is disposed along the bottom surface of the housing 421.

The nozzle unit 40B of the rechargeable cleaner 10B is placed on a holder 110B of a non-contact charger 100B. The holder 110B has an L-shape in side view. The holder 110 is fixed to a wall surface near a floor surface, for example. The part of the holder 110B disposed on the floor surface is provided with a power transmitting coil 103B. In other words, the power transmitting coil 103B is disposed at a position facing the power receiving coil 431B of the head 42 when the nozzle unit 40B is placed on the holder 110B.

The case 21 preferably includes a caught member, such as a hook, that enables the body unit 20 to be caught by a catching member, such as a pin, disposed on the wall surface when the nozzle unit 40B is placed on the holder 110B.

When the nozzle unit 40B according to the present embodiment is placed on the holder 110B of the non-contact charger 100B, the power receiving coil 431B and the power transmitting coil 103B face each other, whereby the battery 26 receives electric power. The rechargeable cleaner 10B according to the present embodiment can be easily charged simply by placing the nozzle unit 40B on the holder 110B of the non-contact charger 100B.

### Fourth Embodiment

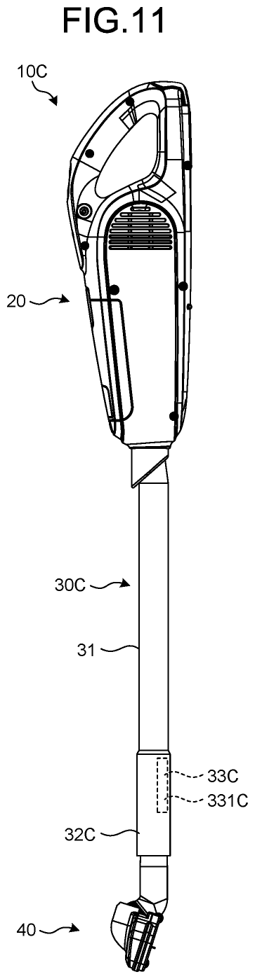

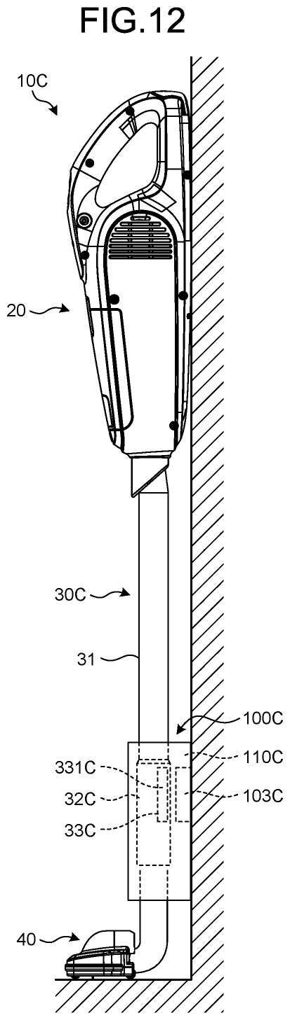

The following describes a rechargeable cleaner 10C according to the present embodiment with reference to FIGS. 11 and 12. FIG. 11 is a side view illustrating an example of the rechargeable cleaner according to a fourth embodiment. FIG. 12 is a view for explaining the method for charging the rechargeable cleaner according to the fourth embodiment. The present embodiment is different from the first embodiment in that a power receiver 33C is disposed in a pipe unit 30C.

The pipe unit 30C includes the pipe member 31, a large diameter part 32C, and the power receiver 33C. The large diameter part 32C has a cylindrical shape having a larger diameter than the pipe member 31. The large diameter part 32C is integrated with the lower part of the pipe member 31. The end of the large diameter part 32C is capable of being coupled to the nozzle unit 40. The power receiver 33C is disposed in the large diameter part 32C.

A holder 110C of a non-contact charger 100C holds the outer periphery of the large diameter part 32C of the pipe unit 30C of the rechargeable cleaner 10C. The holder 110C holds the large diameter part 32C with a surface curved along the outer periphery of the large diameter part 32C. The holder 110C is fixed to a wall surface, for example. The curved surface of the holder 110C is provided with a power transmitting coil 103C. In other words, the power transmitting coil 103C is disposed at a position facing a power receiving coil 331C of the power receiver 33C when the holder 110C holds the pipe unit 40C.

When the large diameter part 32C of the pipe unit 30C according to the present embodiment is held by the holder 110C of the non-contact charger 100C, the power receiving coil 331C of the power receiver 33C and the power transmitting coil 103C face each other, whereby the battery 26 receives electric power. The rechargeable cleaner 10C according to the present embodiment can be easily charged simply by causing the large diameter part 32C of the pipe unit 30C to be held by the holder 110C of the non-contact charger 100C.

The above embodiments describes a pair of the power receiving coil and the power transmitting coil; however, the configuration is not limited thereto. A plurality of pairs of the power receiving coil and the power transmitting coil may be provided.

The first embodiment uses a holder-like non-contact charger 100; however, the non-contact charger 100 may be a plate-like non-contact charger placed on a floor or a work table. In this case, the battery 26 is charged by placing the flat surface part of the case 21 on the plate-like non-contact charger.

### REFERENCE SIGNS LIST

10: rechargeable cleaner, 20: body unit (body), 21: case (housing), 22: suction port, 23: motor, 24: suction fan, 25: dust collection filter (dust collection part), 26: battery, 261, 262, 263: cell, 264: temperature detecting element, 27: handle (handle part), 28: power receiver, 281: power receiving coil, 30: pipe unit (pipe part), 31: pipe member, 40: nozzle unit (suction part), 41: coupler, 42: head, 422: suction port, 50: operating switch, 51: drive switch, 52: stop switch, 54: LED, 60: control circuit board, 62: discharging control FET, 64: charging control FET, 66: charging protection FET, 70: control circuit, 72: cell voltage detector, 74: disconnection detector, 76: protection circuit, 78: resistance, 80: regulator, 82: diode, 100: non-contact charger, 103: power transmitting coil, 110: holder (holding unit)

1. A rechargeable cleaner comprising:
a body including a motor configured to generate suction power capable of sucking dust together with air and a housing that houses the motor;
a rechargeable battery configured to supply electric power to the motor;
a suction part having a suction port capable of sucking dust together with air by the suction power generated by the motor;
a handle part disposed at the body and capable of being gripped by an operator; and
a power receiving coil disposed at a flat surface part of the housing facing the handle part, wherein
the power receiving coil charges the battery by induced power generated by an electric current flowing through a power transmitting coil of a charger disposed facing the power receiving coil.

2. The rechargeable cleaner according to claim 1, wherein
the battery is disposed facing the handle part, and
the power receiving coil is disposed along the battery.

3. The rechargeable cleaner according to claim 1, further comprising:
a dust collection part that communicates with the suction port and houses collected dust, wherein
the power receiving coil is disposed near the dust collection part.

4. The rechargeable cleaner according to claim 3, wherein the power receiving coil is disposed in a housing part provided side by side with the dust collection part and partitioned with a partition wall.

5. A rechargeable cleaner comprising:
a body including a motor configured to generate suction power capable of sucking dust together with air and a housing that houses the motor;
a rechargeable battery configured to supply electric power to the motor;
a suction part having a suction port capable of sucking dust together with air by the suction power generated by the motor; and
a power receiving coil disposed in the suction part, wherein
the power receiving coil charges the battery by induced power generated by an electric current flowing through a power transmitting coil of a charger disposed facing the power receiving coil.

6. The rechargeable cleaner according to claim 5, wherein the power receiving coil is disposed at a flat surface part having the suction port of the suction part.

7. A rechargeable cleaner comprising:
a body including a motor configured to generate suction power capable of sucking dust together with air and a housing that houses the motor;
a rechargeable battery configured to supply electric power to the motor;
a suction part having a suction port capable of sucking dust together with air by the suction power generated by the motor;
a pipe part that couples the body and the suction part; and
a power receiving coil disposed at a position facing a holding unit that holds at least one of the body, the suction part, and the pipe part, wherein
the power receiving coil charges the battery by induced power generated by an electric current flowing through a power transmitting coil of the holding unit disposed facing the power receiving coil.

8. The rechargeable cleaner according to claim 1, wherein the power receiving coil is disposed in the housing.

9. The rechargeable cleaner according to claim 1, further comprising a power reception circuit that connects the power receiving coil and the battery and is configured to convert AC power supplied from the power receiving coil into DC power and convert a DC voltage into a voltage to be supplied to the battery.

10. The rechargeable cleaner according to claim 5, wherein the power receiving coil is disposed in the housing.

11. The rechargeable cleaner according to claim 5, further comprising a power reception circuit that connects the power receiving coil and the battery and is configured to convert AC power supplied from the power receiving coil into DC power and convert a DC voltage into a voltage to be supplied to the battery.

12. The rechargeable cleaner according to claim 7, wherein the power receiving coil is disposed in the housing.

13. The rechargeable cleaner according to claim 7, further comprising a power reception circuit that connects the power receiving coil and the battery and is configured to convert AC power supplied from the power receiving coil into DC power and convert a DC voltage into a voltage to be supplied to the battery.
